(19) United States
(12) Patent Application Publication
(10) Pub. No.: US 2019/0320109 A1
(43) Pub. Date: Oct. 17, 2019

(54) Stabilizing Apparatus Based on Wireless Control and Wireless Shooting System

(71) Applicant: Guilin Feiyu Technology Corporation Ltd., Guilin, Guangxi (CN)

(72) Inventor: Chengyun Wei, Guilin, Guangxi (CN)

(21) Appl. No.: 16/085,598

(22) PCT Filed: Jun. 14, 2018
(86) PCT No.: PCT/CN2018/091186

§ 371 Date: Sep. 17, 2018

(30) Foreign Application Priority Data
Apr. 13, 2018 (CN) 201810330808.4

(51) Int. Cl. H04N 5/232

(52) U.S. Cl. CPC H04N 5/23206; H04W 80/00; H04N 5/2328; H04N 5/23216

(57) ABSTRACT

The present invention provides stabilizing apparatus based on wireless control, wherein the stabilizing apparatus comprises a stabilizer body and a wireless control module, a wireless communication module and a camera control module respectively mounted on the stabilizer body; the camera control module sends a control signal to the wireless control module when receiving a trigger signal; the wireless control module sends a control signal to the wireless communication module when receiving the control signal sent by the camera control module, receives a camera command signal sent by the wireless communication module; the wireless communication module is connected with a camera according to a wireless protocol, and receives the control signal sent by the wireless control module, and sends the camera command signal to the wireless control module. The beneficial effect of the invention is breaking limitation that the stabilizer and the camera are connected with a conventional data cable.

### FIELD OF THE INVENTION

The present invention relates to shooting equipment, more particularly to a stabilizing apparatus based on wireless control and a wireless shooting system.

### BACKGROUND OF THE INVENTION

So far, the stabilizer is used to fix the target object, adjust the posture of the target object and stabilize the target object in a determined posture, so as to enable the target object to achieve stable, smooth, and multi-angle shooting. A camera is fixed on a stabilizer to maintain balance, and a user controls the camera and adjusts the camera's functional parameters through the stabilizer. Since the user has to adjust the function parameters of the camera when utilizing the stabilizer for shooting, the shooting efficiency is lowered and the user experience is poor.

In the prior art, a conventional data cable is usually used to control the camera, and the stabilizer is connected to the camera through the data cable. However, since the stabilizer will rotate during working, it will lead to unstable situation, and it is inconvenient to utilize the data connection line, which will affect the balance of the center of gravity of the stabilizer, which in turn affects stability and balance function of the stabilizer to the camera. Therefore, the stabilizer with the data cable is not doing well in terms of operability and portability, and different cameras need the connection lines with different interfaces, which undoubtedly increases product cost.

### SUMMARY OF THE INVENTION

According to the above statement, an object of the present invention is to provide a stabilizing apparatus based on wireless control and a wireless shooting system, so as to solve the problem that the existing stabilizer uses the data cable to control the camera, which is not ideal in terms of operability and portability. The wire bond between the stabilizer and the camera is effectively eliminated, thereby improving the operability of the stabilizer and portability, as well as user experience and reducing product cost.

In order to solve the above problem, the present disclosure provides a stabilizing apparatus based on wireless control, wherein the stabilizing apparatus comprises a stabilizer body and a wireless control module, a wireless communication module and a camera control module respectively mounted on the stabilizer body;

the camera control module sends a control signal to the wireless control module when receiving a trigger signal;

the wireless control module sends a control signal to the wireless communication module when receiving the control signal sent by the camera control module, receives a camera command signal sent by the wireless communication module;

the wireless communication module is connected with a camera according to a wireless protocol, and receives the control signal sent by the wireless control module, and sends the camera command signal to the wireless control module.

Preferably, the wireless control module comprises a preset number of operating buttons;

the operating buttons send the trigger signal when receiving trigger signals.

Preferably, the camera control module further comprises a display screen;

the display screen is configured to display a camera parameter adjustment interface and receive a display signal sent by the wireless control module to display a corresponding parameter change when the operating buttons receive the trigger signals.

Preferably, the display screen is a LED display screen or a LCD display screen.

Preferably, the camera control modules comprise a touch screen;

the touch screen is configured to display a camera parameter adjustment interface, send a trigger signal to the wireless control module when receiving the trigger signal, and display a corresponding parameter change; or

the touch screen is configured to wirelessly communicate with the camera and send a trigger signal to the camera when receiving the trigger signal, to adjust parameters of the camera and display a corresponding parameter change.

Preferably, the touch screen is detachably mounted on the stabilizer body, and the touch screen is electrically connected to the wireless control module.

Preferably, the wireless communication module is wirelessly connected to the camera through a wireless communication method, wherein the wireless communication method is selected from the group consisting of a WiFi communication method, a BLE communication method, a 10T communication method, and combinations thereof.

Preferably, the apparatus further comprises a mobile terminal wireless receiving module;

the mobile terminal wireless receiving module sends a mobile terminal control signal to the wireless control module when receiving a wireless signal from a mobile terminal.

Preferably, the stabilizer body comprises a posture control module; the posture control module comprises a bracket used for fixing a camera, a posture controller, an X-axis motor, a Y-axis motor and a Z-axis motor that are orthogonally distributed in a space;

the X-axis motor is configured to control pitching motion, the Y-axis motor is configured to control rolling motion, the Z-axis motor is configured to control directional motion; a rotation axis of the Z-axis motor being connected to a stator of the Y-axis motor; a rotor of the Y-axis motor being connected to a stator of the X-axis motor; a rotation axis of the X-axis motor being connected to the bracket through a posture board.

In order to solve the same problem, the present disclosure further provides a wireless shooting system, wherein the wireless shooting system comprises a camera and any of the above stabilizing apparatuses based on wireless control; the camera is detachably mounted on the stabilizer body.

Compared with the prior art, the beneficial effect of the embodiments according to the present invention is breaking limitation that the stabilizer and the camera are connected with a conventional data cable by means of the wireless connection between the wireless communication module and the camera, thereby realizing the wireless connection and control functions between the stabilizer and the camera. The influence of the data cable on the balance of the stabilizer is avoided, thereby improving the operability and portability of the stabilizer, as well as improving the user experience and reducing the product cost.

By acquiring a user's operation instruction, the camera control module sends a control signal to the wireless control module when receiving a trigger signal, so that the wireless control module implement signal processing and sends a control signal to the wireless communication module, so that the camera wirelessly connected to the wireless communication module can perform corresponding control operations and parameter adjustment according to the user's requirements. The stabilizer can wirelessly adjust parameters such as stabilizer wireless control camera focus, ISO, WB, and exposure, thereby improving user experience.

### BRIEF DESCRIPTION OF THE DRAWINGS

FIG. 1 is a schematic structural diagram of a stabilizing apparatus according to the first embodiment of the present disclosure;

FIG. 2 is a schematic structural diagram of a stabilizing apparatus according to the second embodiment of the present disclosure;

FIG. 3 is a schematic structural diagram of a stabilizing apparatus according to the third embodiment of the present disclosure;

FIG. 4 is a schematic structural diagram of a stabilizing apparatus according to the third embodiment of the present disclosure;

Description of the reference numerals will be listed as below:

1. the camera control module; 11. the operating buttons; 12. the display screen; 13. the touch screen; 2. the wireless control module; 3. the wireless communication module; 4. the camera; 5. the mobile terminal wireless receiving module; 6. the mobile terminal.

### DETAILED DESCRIPTION OF ILLUSTRATED EMBODIMENTS

The technical solutions of the embodiments according to the present invention are clearly and fully described as below with reference to the accompanying drawings in the embodiments of the present invention. Apparently, the embodiments to be described are merely a part rather than all of the embodiments of the present invention. All other embodiments obtained by persons with ordinary skills in the art based on the embodiments of the present invention without creative efforts shall fall within the protection scope of the present invention.

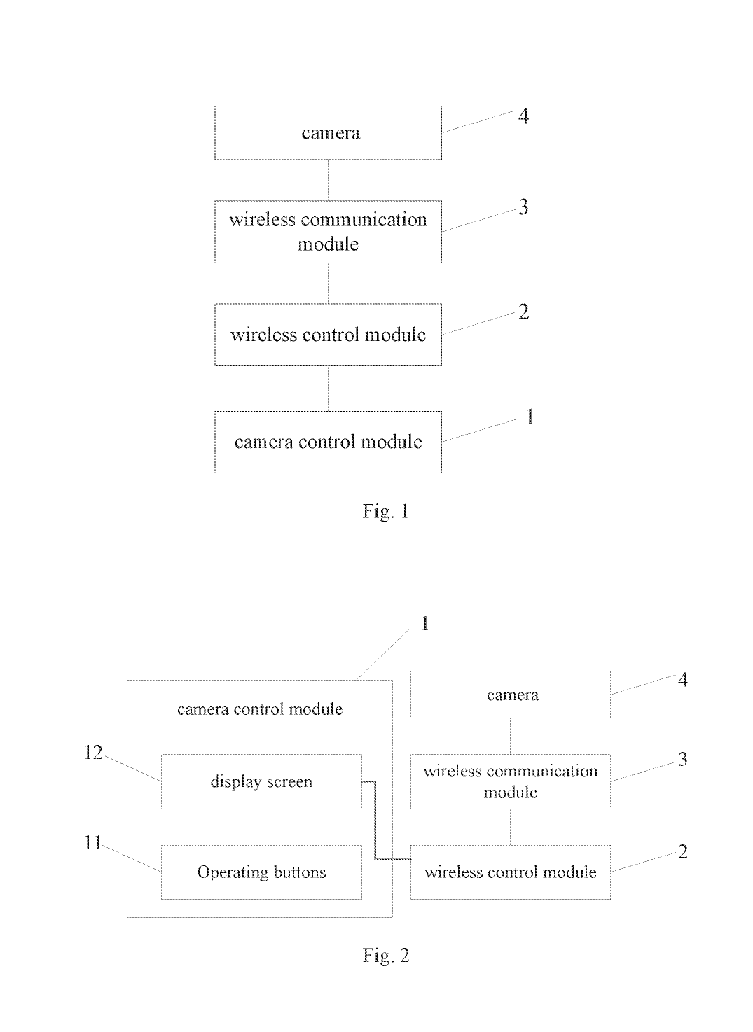

With reference to FIG. 1, a stabilizing apparatus based on wireless control according to a preferred present embodiment, comprises a stabilizer body and a wireless control module 2, a wireless communication module 3 and a camera control module 1 respectively mounted on the stabilizer body.

A trigger signal output end of the camera control module is electrically connected with a trigger signal input end of wireless control module 2; a control signal output end of the wireless control module 2 is electrically connected with a control signal input end of the wireless communication module 3; the wireless communication module 3 is wirelessly connected to a camera 4 through a wireless communication method.

The camera control module 1 sends a control signal to the wireless control module 2 when receiving a trigger signal;

The wireless control module 2 sends a control signal to the wireless communication module 3 when receiving the control signal sent by the camera control module 1, receives a camera command signal sent by the wireless communication module 3;

The wireless communication module 3 is connected with the camera 4 according to a wireless protocol, and receives the control signal sent by the wireless control module 2, and sends the camera command signal to the wireless control module 2.

The wireless communication module 3 has a transceiving function. When wirelessly communicating with the camera 4, the wireless communication module 3 can send a wireless control command to the camera 4 while receiving an instruction response command or camera event command of the camera 4 and transmitting to the wireless control module 2, so that the wireless control module 2 can perform signal processing.

In the present embodiment, the beneficial effect is breaking limitation that the stabilizer and the camera are connected with a conventional data cable by means of the wireless connection between the wireless communication module and the camera, thereby realizing the wireless connection and control functions between the stabilizer and the camera. The influence of the data cable on the balance of the stabilizer is avoided, thereby improving the operability and portability of the stabilizer, as well as improving the user experience and reducing the product cost.

By acquiring a user's operation instruction, the camera control module 1 sends a control signal to the wireless control module 2 when receiving a trigger signal, so that the wireless control module 2 implement signal processing and sends a control signal to the wireless communication module 3, so that the camera 4 wirelessly connected to the wireless communication module 3 can perform corresponding control operations and parameter adjustment according to the user's requirements. The stabilizing apparatus can wirelessly adjust parameters such as stabilizer wireless control camera focus, ISO, WB, and exposure, thereby improving user experience.

In the present embodiment, as should be noted that the wireless communication module 3 communicates with the camera 4 through a wireless SDK and a cooperation protocol. The wireless communication method is selected from but will not be limited to the group consisting of a WiFi communication method, a BLE communication method, a 10T communication method, and combinations thereof, as will not be described herein.

With reference to FIG. 2, in a preferred embodiment according to the present embodiment, to rationalize the structure, the wireless control module 1 comprises a preset number of operating buttons 11; output ends of the operating buttons 11 are respectively electrically connected with trigger signal output ends of the wireless control module 1. The operating buttons 11 send trigger signals when receiving the trigger signals.

As can be understood, the operating buttons 11 can be power switch buttons, camera focus buttons or parameter selection buttons, etc. during operation, the user can select an operating button 11 with corresponding function according to the shooting condition of the camera 4, and press the operation button 11 to trigger it, the functions of the camera 4, such as parameter adjustment and power switch, are realized.

With reference to FIG. 2, in a preferred embodiment according to the present embodiment, to rationalize the structure, the camera control module further comprises a display screen 12; a displaying input end of the display screen 12 is electrically connected with a displaying output end of the wireless control module 2.

The display screen 12 is configured to display a camera parameter adjustment interface and receive a display signal sent by the wireless control module 2 to display a corresponding parameter change when the operation buttons 11 receive the trigger signals.

In the present embodiment, the display screen 12 is a LED display screen or a LCD display screen.

In a preferred embodiment according to the present embodiment, to rationalize the structure, the camera control module 1 comprises a touch screen 13; the touch screen 13 is configured to display a camera parameter adjustment interface, send a trigger signal to the wireless control module 2 when receiving the trigger signal, and display a corresponding parameter change.

In the present embodiment, the touch screen 13 indirectly controls the camera 4; when the camera control module adopts the touch screen 13, the touch screen 13 acquires a user's operation instruction and sends a control signal to the wireless control module when receiving a trigger signal, so that the wireless control module implement signal processing and sends a control signal to the wireless communication module, so that the camera wirelessly connected to the wireless communication module can perform corresponding control operations and parameter adjustment according to the user's requirements. The stabilizer can wirelessly adjust parameters such as stabilizer wireless control camera focus, ISO, WB, and exposure, thereby improving user experience. Meanwhile, the touch screen 13 has a display function, and the interface settings of the touch screen 13 and the function keys are set according to actual needs.

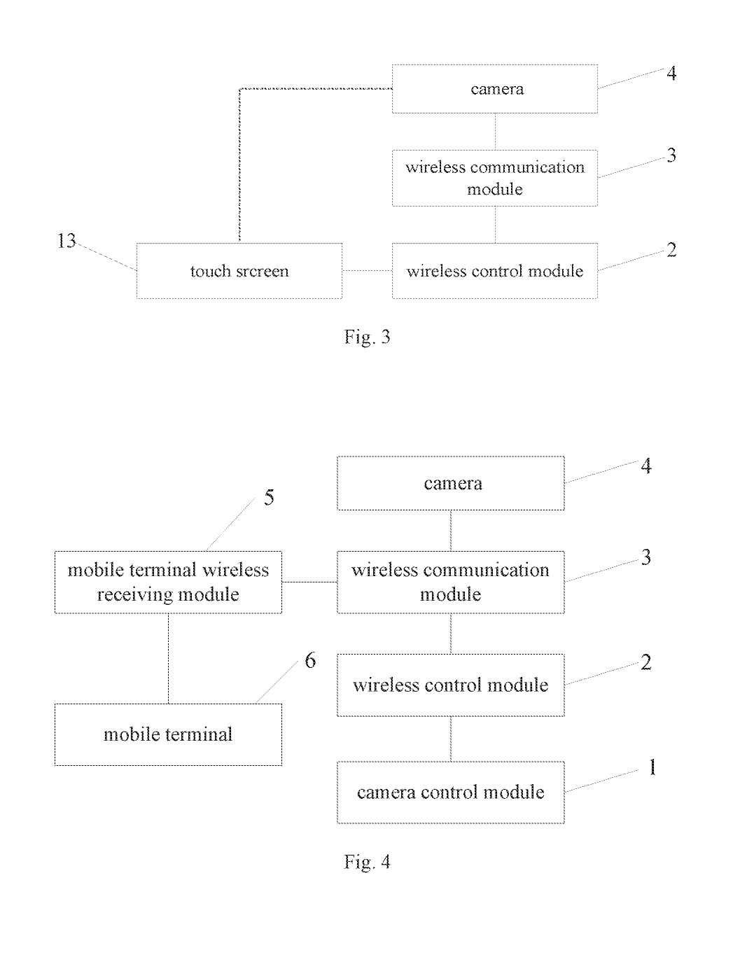

With reference to FIG. 3, in a preferred embodiment according to the present embodiment, to rationalize the structure, the touch screen 13 is electrically connected with the wireless control module 2; the touch screen 13 is wirelessly connected to the camera 4 through a wireless communication method; the touch screen 13 sends a trigger signal to the camera 4 when receiving the trigger signal to adjust parameters of the camera 4 and display a corresponding parameter change.

In the present embodiment, the touch screen 13 directly controls the camera 4; the touch screen 13 is wirelessly communicated with the camera 4, and the camera 4 is fixed on the stabilizer body. When the camera control module adopts the touch screen 13, the touch screen 13 acquires a user's operation instruction and sends a control signal to the wireless control module when receiving a trigger signal, so that the wireless control module implement signal processing and sends a control signal to the wireless communication module, so that the camera wirelessly connected to the wireless communication module can perform corresponding control operations and parameter adjustment according to the user's requirements. The stabilizer can wirelessly adjust parameters such as stabilizer wireless control camera focus, ISO, WB, and exposure, thereby improving user experience. Meanwhile, the touch screen 13 has a display function, and the interface settings of the touch screen 13 and the function keys are set according to actual needs.

In a preferred embodiment according to the present embodiment, to rationalize the structure, the touch screen 13 is detachably mounted on the stabilizer body, and the touch screen 13 is electrically connected to the wireless control module 2, which is applicable for touch screen 13 of different models and functions and the camera 4 of different models, thereby improving the user experience and reducing the cost. At the same time, the touch screen 13 can be more easily disassembled and installed back onto the stabilizer body when problems arise and disassembling and repairing are required.

In a preferred embodiment according to the present embodiment, to rationalize the structure, the wireless communication module 3 is wirelessly connected to the camera 4 through WiFi communication method or BLE communication method.

With reference to FIG. 4, in a preferred embodiment according to the present embodiment, to rationalize the structure, the stabilizing apparatus further comprises a mobile terminal wireless receiving module 5; a signal input end of the mobile terminal wireless receiving module 5 is wirelessly connected with the mobile terminal 6; a signal output end of the mobile terminal wireless receiving module 5 is wirelessly connected with the wireless control module 2. The mobile terminal wireless receiving module 5 sends a mobile terminal control signal to the wireless control module 2 when receiving a wireless signal from a mobile terminal 6. As can be understood, the mobile terminal 6 is a device such as a mobile phone or a tablet in the prior art, and sends a control command to the mobile terminal wireless receiving module 5 through corresponding APP software. Therefore, users can directly adjust parameters of the camera 4 and remotely control the camera 4 by taking advantage of a mobile device such as a mobile phone, thereby improving convenience, practicability, as well as the user experience.

In a preferred embodiment according to the present embodiment, to rationalize the structure, the stabilizer body comprises a posture control module; the posture control module comprises a bracket used for fixing a camera, a posture controller, an X-axis motor, a Y-axis motor and a Z-axis motor that are orthogonally distributed in a space.

The X-axis motor is configured to control pitching motion, the Y-axis motor is configured to control rolling motion, the Z-axis motor is configured to control directional motion; a rotation axis of the Z-axis motor being connected to a stator of the Y-axis motor; a rotor of the Y-axis motor being connected to a stator of the X-axis motor; a rotation axis of the X-axis motor being connected to the bracket through a posture board.

With reference to FIG. 1 to FIG. 4, in order to solve the same problem, the present disclosure further provides a wireless shooting system, wherein the wireless shooting system comprises a camera and the stabilizing apparatus based on wireless control; the camera is detachably mounted on the stabilizer body.

In conclusion, the present disclosure provides a stabilizing apparatus based on wireless control, wherein the stabilizing apparatus comprises a stabilizer body and a wireless control module 2, a wireless communication module 3 and a camera control module 1 respectively provided in the stabilizer body. The camera control module 2 sends a control signal to the wireless control module 2 when receiving a trigger signal; The wireless control module 2 sends a control signal to the wireless communication module 3 when receiving the control signal sent by the camera control module 1, and receives a camera command signal sent by the wireless communication module 3; The wireless communication module 3 is connected with the camera 4 according to a wireless protocol, and receives the control signal sent by the wireless control module 2, and sends the camera command signal to the wireless control module 2.

The present disclosure further provides a wireless shooting system.

Compared with the prior art, the beneficial effect of the embodiments according to the present invention is breaking limitation that the stabilizer and the camera 4 are connected with a conventional data cable by means of the wireless connection between the wireless communication module 3 and the camera 4, thereby realizing the wireless connection and control functions between the stabilizer and the camera 4. The influence of the data cable on the balance of the stabilizer is avoided, thereby improving the operability and portability of the stabilizer, as well as improving the user experience and reducing the product cost.

By acquiring a user's operation instruction, the camera control module 1 sends a control signal to the wireless control module 2 when receiving a trigger signal, so that the wireless control module 2 implement signal processing and sends a control signal to the wireless communication module 3, so that the camera wirelessly connected to the wireless communication module 3 can perform corresponding control operations and parameter adjustment according to the user's requirements. The stabilizer can wirelessly adjust parameters such as stabilizer wireless control camera focus, ISO, WB, and exposure, thereby improving user experience.

The foregoing descriptions are merely exemplary embodiments of the present invention, but are not intended to limit the present disclosure. Any modifications, equivalent substitutions, and improvements made by those skilled in the art within the spirit and principle of the present disclosure shall fall within the protection scope of the present disclosure.

1. A stabilizing apparatus based on wireless control, wherein the stabilizing apparatus comprises a stabilizer body and a wireless control module, a wireless communication module and a camera control module respectively mounted on the stabilizer body;
the camera control module sends a control signal to the wireless control module when receiving a trigger signal;
the wireless control module sends a control signal to the wireless communication module when receiving the control signal sent by the camera control module, receives a camera command signal sent by the wireless communication module;
the wireless communication module is connected with a camera according to a wireless protocol, receives the control signal sent by the wireless control module, and sends the camera command signal to the wireless control module.

2. The stabilizing apparatus based on wireless control according to claim 1, wherein the wireless control module comprises a preset number of operating buttons;
the operating buttons send trigger signals when receiving the trigger signals.

3. The stabilizing apparatus based on wireless control according to claim 2, wherein the camera control module further comprises a display screen;
the display screen is configured to display a camera parameter adjustment interface and receive a display signal sent by the wireless control module to display a corresponding parameter change when the operating buttons receive the trigger signals.

4. The stabilizing apparatus based on wireless control according to claim 3, wherein the display screen is a LED display screen or a LCD display screen.

5. The stabilizing apparatus based on wireless control according to claim 1, wherein the camera control module comprises a touch screen;
the touch screen is configured to display a camera parameter adjustment interface, send a trigger signal to the wireless control module when receiving the trigger signal, and display a corresponding parameter change; or
the touch screen is configured to wirelessly communicate with the camera and send a trigger signal to the camera when receiving the trigger signal, to adjust parameters of the camera and display a corresponding parameter change.

6. The stabilizing apparatus based on wireless control according to claim 5, wherein the touch screen is detachably mounted on the stabilizer body, and the touch screen is electrically connected to the wireless control module.

7. The stabilizing apparatus based on wireless control according to claim 1, wherein the wireless communication module is wirelessly connected to the camera through a wireless communication method, wherein the wireless communication method is selected from the group consisting of a WiFi communication method, a BLE communication method, a 10T communication method, and combinations thereof.

8. The stabilizing apparatus based on wireless control according to claim 1, wherein the stabilizing apparatus further comprises a mobile terminal wireless receiving module;
the mobile terminal wireless receiving module sends a mobile terminal control signal to the wireless control module when receiving a wireless signal from a mobile terminal.

9. The stabilizing apparatus based on wireless control according to claim 1, wherein the stabilizer body comprises a posture control module; the posture control module comprises a bracket used for fixing a camera, a posture controller, an X-axis motor, a Y-axis motor and a Z-axis motor that are orthogonally distributed in a space;
the X-axis motor is configured to control pitching motion, the Y-axis motor is configured to control rolling motion, the Z-axis motor is configured to control directional motion; a rotation axis of the Z-axis motor being connected to a stator of the Y-axis motor; a rotor of the Y-axis motor being connected to a stator of the X-axis motor; a rotation axis of the X-axis motor being connected to the bracket through a posture board.

10. A wireless shooting system, wherein the wireless shooting system comprises a camera and the stabilizing apparatus based on wireless control according to claim 1; the camera is detachably mounted on the stabilizer body.

11. A wireless shooting system, wherein the wireless shooting system comprises a camera and the stabilizing apparatus based on wireless control according to claim 2; the camera is detachably mounted on the stabilizer body.

12. A wireless shooting system, wherein the wireless shooting system comprises a camera and the stabilizing apparatus based on wireless control according to claim 3; the camera is detachably mounted on the stabilizer body.

13. A wireless shooting system, wherein the wireless shooting system comprises a camera and the stabilizing apparatus based on wireless control according to claim 4; the camera is detachably mounted on the stabilizer body.

14. A wireless shooting system, wherein the wireless shooting system comprises a camera and the stabilizing apparatus based on wireless control according to claim 5; the camera is detachably mounted on the stabilizer body.

15. A wireless shooting system, wherein the wireless shooting system comprises a camera and the stabilizing apparatus based on wireless control according to claim 6; the camera is detachably mounted on the stabilizer body.

16. A wireless shooting system, wherein the wireless shooting system comprises a camera and the stabilizing apparatus based on wireless control according to claim 7; the camera is detachably mounted on the stabilizer body.

17. A wireless shooting system, wherein the wireless shooting system comprises a camera and the stabilizing apparatus based on wireless control according to claim 8; the camera is detachably mounted on the stabilizer body.

18. A wireless shooting system, wherein the wireless shooting system comprises a camera and the stabilizing apparatus based on wireless control according to claim 9; the camera is detachably mounted on the stabilizer body.
